(19) United States
(12) Patent Application Publication
(10) Pub. No.: US 2007/0095388 A1
(43) Pub. Date: May 3, 2007

(54) Photovoltaic roof-top components, a photovoltaic IRMA roofing system, and a photovoltaic roofing system

(76) Inventors: Thomas J. Mergola, Mahwah, NJ (US); Michael Zemsky, Westfield, NJ (US)

Correspondence Address: MALCOLM J. CHISHOLM, JR.;ATTORNEY AT LAW, P. O. BOX 278, 220 MAIN STREET, LEE, MA, 01238, US

(21) Appl. No.: 11/590,598

(22) Filed: Oct. 31, 2006

Related U.S. Application Data
(60) Provisional application No. 60/732,501, filed on Nov. 2, 2005.

(51) Int. Cl. H02N 6/00

(52) U.S. Cl. 136/251

(57) ABSTRACT

An improved photovoltaic roofing system (10) includes a roofing membrane (12) overlying a top surface (14) of a roof deck (16), an insulation layer (18) above the roofing membrane (12) and a photovoltaic panel (20) above the insulation layer (18). The improved photovoltaic insulation layer (18) component defines a predetermined number of drainage channels (30) between the insulation layer (18) and the roofing membrane, and/or a predetermined insulation layer thickness, and the predetermined number of drainage channels (30) and/or thickness is a function of variable drainage requirements and/or variable insulation requirements of the roofing system (10). A photovoltaic IRMA roofing system (72) replaces traditional IRMA roofing system (73) ballast materials (79) with a combined weight of concrete topped (83) insulation layer and photovoltaic panels (80) to meet a predetermined minimum weight per unit area requirement of a specific roofing system (72).

### CROSS REFERENCE TO RELATED APPLICATION

This Application claims the benefit of U.S. Provisional Patent Application Ser. No. 60/732,501 that was filed Nov. 2, 2005, entitled “Photovoltaic Roof-Top Components, Photovoltaic Roof-Top Assemblies, and Photovoltaic Roofing Systems”.

### TECHNICAL FIELD

The present invention relates to photovoltaic roof-top components, photovoltaic roof-top assemblies, and photovoltaic systems that convert solar energy directly into electricity.

BACKGROUND ART

Roof-top assemblies that utilize solar energy are well known, and photovoltaic roof-top components that convert solar energy directly into electrical energy are increasingly common, especially on large commercial, essentially flat roofs. Such photovoltaic roof-top assemblies generally include photovoltaic panels on top of a roofing membrane that overlies a top surface of a roof deck.

A well known roofing system includes use of a roofing membrane, and then a loosely laid insulation layer above the roofing membrane, and then a layer of ballast material, such as stone or concrete layers on the insulation layer to secure the insulation against wind disruption, etc. Such roofing systems are often referred to as “inverted roofing membrane assemblies”, or by the acronym IRMA or PMR. By having the insulation on top of the roofing membrane, instead of under the membrane, IRMA systems protect the membrane from deterioration due to exposure to ultraviolet light and thermal stress. However, the ballast materials add a substantial weight load to the roof, and also require substantial cost and effort in applying the ballast materials to the roof. Each IRMA roofing system requires a predetermined minimum weight per unit area to adequately secure against disruption by wind or other weather events. The minimum weight per unit area cannot exceed a maximum design weight load for the underlying roof structure.

For example, a common predetermined weight per unit area for an IRMA roofing system could be about five to about twelve pounds per square foot. Consequently, such newly constructed buildings must design for the additional loads and existing IRMA roofs may present weight limitation challenges if it is desired to add a photovoltaic roofing system to the IRMA roof. In addition the buildings underlying roof structure must be analyzed for reserve load capability when it is desired to replace an existing conventional membrane over insulation roofing system with an IRMA roofing system or a photovoltaic IRMA roofing system.

Other problems associated with roof-top assemblies using photovoltaic roofing components include efforts to minimize penetration and related possible leakage through the roofing membrane by apparatus used to secure the panels to the roof membrane; resistance to wind forces that may rip photovoltaic panels off of a roof deck; stabilizing temperatures experienced during operation of the photovoltaic panels; drainage of rain and melt water under such photovoltaic components; and a number of related challenges.

For example, U.S. Pat. No. 4,886,554 to Woodring et al. shows a solar roofing system that uses tapered insulation blocks to generate flow of rain water off of surfaces of the photovoltaic cells and then between the insulation blocks and adjacent pavers to direct rain water over the roofing membrane and away from the system. U.S. Pat. No. 5,316,592 to Dinwoodie discloses use of a plurality of insulation blocks between a roofing membrane and a photovoltaic module wherein rainwater flows off of the module surfaces and between insulation blocks of adjacent modules to then flow onto the roofing membrane away from the photovoltaic modules. These patents indicate that the types of flat roofs appropriate for use of such photovoltaic modules include modest slopes for drainage of rain water, which is well understood.

As a further example of problems addressed in the field of photovoltaic roofing modules, U.S. Pat. No. 5,505,788 to Dinwoodie shows elaborate means for regulating temperature of the photovoltaic modules, including use of phase change materials and fluid flow conduits adjacent back sides of the modules. This patent also points out that rain water will drain between joints between the modules. Additionally, U.S. Pat. No. 5,746,839 to Dinwoodie discloses use of pre-formed spacers supporting photovoltaic modules above a roofing membrane, or above an insulation block, to support photovoltaic modules, wherein geometry of the spacers is configured to reduce the force of wind uplift on the overall system.

These and other known patents endeavor to resolve a number of beguiling issues related to installation of photovoltaic modules on essentially flat roofs. However, no known patent or known photovoltaic roofing system efficiently resolves major challenges that have become more pressing with the development of modern, stringent building codes. In particular, new “IBC” codes call for at least a one-quarter inch per foot of run slope for positive drainage on all commercial flat roofs. By requiring such significant drainage slope, known photovoltaic modules are essentially incapable of effectively dealing with a substantial flow of water from upstream of the module in all types of flat or moderately sloped roof conditions. In some circumstances, a sudden, high rain-fall rate may lead to such a flow of water from areas upstream of the modules and then onto the modules, so that the modules may be damaged dislodged from their positions on the roof and also causing damage to the membrane.

Additionally, it has been determined that standardized insulation layers beneath photovoltaic modules may give rise to unacceptable dew points below roofing membranes in certain roofing structures, thereby leading to unacceptable condensation of moisture below a roofing membrane upon a roofing deck. Such condensation may lead to corrosion of metal roofing decks and/or rotting of wooden deck materials & membrane.

Other problems associated with such roofing systems using photovoltaic roof-top components include excessive weight of such known systems, and difficulties associated with repair or upgrading of the photovoltaic panel components of the roofing assemblies. Some older flat roofs are only capable of supporting between four to five pounds per square foot, and most known photovoltaic roofing systems weigh substantially more. Hence, there is a need for a lightweight photovoltaic roofing system.

Moreover, typical and known solar roofing assemblies, such as those disclosed in the aforesaid U.S. Pat. Nos. 5,316,592 and 5,505,788 to Dinwoodie, show that for convenience of manufacture and installation, photovoltaic panels are manufactured to be integral with insulation layers and/or with spacers between the panels and insulation layers below the photovoltaic panels. While that may facilitate manufacture and installation, it is know that frequently only one photovoltaic panel may fail or be damaged by accidental impact by debris resulting from severe weather, falling installation tools, and/or misuse etc.

It is also known that large, flat roofs may have photovoltaic roofing systems with literally hundreds of photovoltaic panels. To remove and replace one or only several photovoltaic panels of such a system is extremely difficult where the photovoltaic panels are integral with spacers and/or an insulation layers below the panels. Removal and disruption of a section of the insulation layer raises risks of damage to the underlying roofing membrane, and adjacent panels. Additionally, environmentally friendly technology such as photovoltaics is developing rapidly, and the quality of photovoltaic panels is changing and is expected to continually change as the panels become more efficient. However, to upgrade known photovoltaic roofing systems may require removal of the entire system because the photovoltaic panels are known to be integral with insulation layers and spacers below the panels.

Accordingly, there is a need for a photovoltaic roofing system that may be easily manufactured and applied to essentially flat roofs that provides for efficient and effective drainage of rain water and/or snow-melt water, and that also allows for variable insulation of a photovoltaic roof panel to prevent deterioration of the roof deck or membrane. There is also a need for a photovoltaic roofing system that facilitates removal of system components for repair and/or upgrading, and that also provides flexibility in weight of system components so that the photovoltaic roofing system may be installed on roofs capable of supporting modest loads.

### SUMMARY OF THE INVENTION

The invention includes improved photovoltaic roof-top components that may be used alone or as part of photovoltaic roofing assemblies or systems. An improved photovoltaic insulation layer includes a top surface and an opposed bottom surface, wherein the bottom surface defines a predetermined number of drainage channels, and includes a predetermined insulation layer thickness between a top surface and the opposed bottom surface. The photovoltaic roofing system includes a roofing membrane overlying a top surface of a roof deck; the improved photovoltaic insulation layer above the roofing membrane; and a photovoltaic panel above the insulation layer. The predetermined number of drainage channels between the insulation layer and the roofing membrane is a function of variable drainage requirements of the roofing system that are appropriate for a specific roof deck to which the system is installed. Additionally, the predetermined insulation layer thickness between opposed top and bottom surfaces is a function of variable insulation requirements of the insulation layer to address dew point and thermal design issues.

The invention also includes a photovoltaic IRMA roofing system for application to a traditional inverted roofing membrane assembly (“IRMA”) roof system. The photovoltaic IRMA roofing system includes a roofing membrane overlying a top surface of a roof deck; an insulation layer above the roofing membrane; ballast material installed above the insulation layer; and a photovoltaic panel secured above the ballast material. The combined weight of the ballast material and the photovoltaic panel are equal to or greater than a predetermined minimum weight per unit area for the roofing system. The preferred ballast material in the photovoltaic IRMA roofing system is a concrete topping secured to the top of the insulation layer.

By replacing a traditional layer of ballast material in an IRMA roofing system with the photovoltaic panel and concrete topping on the insulation layer, the photovoltaic IRMA roofing system efficiently satisfies the predetermined minimum weight per unit area requirement of any specific roofing system while minimizing any risk of exceeding a maximum weight load of the roof. This is particularly valuable when improving an existing IRMA roof by removing existing ballast materials and replacing them with the combined weight of the concrete layer and the photovoltaic panels. This also adds insulation to enhance the energy efficiency of the building. The photovoltaic IRMA roofing system also minimizes a weight load, cost of materials and assembly for any new roof that is to include photovoltaic panels.

(For purposes herein, use of the word “above” with respect to adjacent components is to mean with respect to a direction of gravity. In other words, where an “insulation layer is secured above a roofing membrane”, that is to means the roofing membrane is closer the center of the earth than is the insulation layer.)

An alternative embodiment of the photovoltaic roofing system of the present invention is referred to for convenience as a “dew-point sensitive roofing system”, and includes the above described roofing membrane, insulation layer and photovoltaic panel above the insulation layer, and also includes a sub-membrane insulation layer secured between the top surface of the roof deck and the roofing membrane such as would occur in an installation of photovoltaic panels over an existing roof or as part of an engineered combination of photovoltaic panels and a new roofing system having a membrane above insulation and decking. The sub-membrane insulation layer defines a predetermined sub-membrane insulation layer thickness between the top surface of the roof deck and the roofing membrane. The above membrane insulation layer in this dew-point sensitive roofing system must define a predetermined thickness that is a function of the sub-membrane insulation layer thickness so that the above membrane insulation layer has a greater “R” (resistance to movement of heat) value than the sub-membrane insulation layer. This dew-point sensitive roofing system alternative embodiment of the invention provides advantages of a protected membrane (“inverted roofing membrane assemblies”, or by the acronym “IRMA”, or “PMR”) roofing system in all applications by combining the dew point sensitive system insulation with a ballast layer consisting of the weight of the photovoltaic glass panel and the weight of a cementitious face of an uppermost layer of insulation. The advantages include longer membrane life due to a more constant membrane temperature and preventing damaging ultraviolet rays from reaching the membrane.

In use of the improved photovoltaic roofing components and system, the area of the roof deck covered by the system would be measured, and the particular position of the system with respect to potential upstream to downstream flow would also be determined so that potential upstream flow through the system could then be measured. With at least these two variables, a user could then determine the variable drainage requirements of the roofing system for a particular installation, including direction and volume of flow. Measurement of the total volume of water that must be moved from the top surface of the photovoltaic system through the system, as well as through the system from flow of water on the roof deck upstream of the system, determines the total flow capacity of the drainage channels defined within the insulation layer above the roofing membrane. The insulation layer would then be selected and/or manufactured to have defined drainage channels that provide adequate flow and directionality for the measured drainage requirements of that particular installation of the present photovoltaic roofing system.

Additionally, prior to installation, the thickness of the insulation layer of the photovoltaic panel would be selected based upon the insulation layer of a particular existing or new roofing system upon which the photovoltaic panels are being installed. The thickness of the insulation layer would be selected based upon variable insulation requirements of a particular roofing system being installed on a particular roof. Determination of a predetermined thickness of the insulation layer would include measurement of the “R” factor of the particular existing or new roof deck or roofing system to which the photovoltaic roofing system is being installed.

Perhaps more importantly, for certain roof decks, such as metal roofs that employ an insulation layer (the “sub-membrane insulation layer” referred to above) under the roofing membrane over metal ribs of a metal deck, it is critically important that the R factor of the sub-membrane insulation layer, and therefore the thickness of the sub-membrane insulation layer, be selected to make sure that the “R” value above the roofing membrane is greater than the “R” factor below the roofing membrane so that condensation between the roofing membrane and the roof deck is avoided. This involves not only a measurement of the R factor and hence thickness of the sub-membrane insulation layer, but also a measurement of the R factor of the roof deck itself, as well as the R factor of the insulation layer between the roofing membrane and the photovoltaic cell. It is to be understood that the “dew point sensitive” embodiment of the roofing system may include retrofitting an existing roof-top system that employs sub-membrane insulation layers and is not limited to newly applied photovoltaic roofing system. In such existing roof-top assemblies having sub-membrane insulation layers, the “R” value of the sub-membrane insulation may simply be measured by taking a core sample by drilling, etc. That sub-membrane “R” factor is then one of the variables used to determine the thickness of the insulation layer above the roofing membrane. Therefore, the present photovoltaic roofing components and roofing systems provide for application of insulation layers of predetermined thicknesses that are appropriate for the specific insulation requirements of the roof deck to which the roofing system is to be installed.

Preferred embodiments of the improved photovoltaic roofing components and photovoltaic roofing system and improved photovoltaic insulation layer also include drainage channels that are both parallel to an axis of gravity flow of water draining through the system, and that are also not parallel to the axis of gravity of flow and that intersect with the channels parallel to the gravity axis of flow. This may appear as the insulation layer having an approximately checked appearance on a surface closest to the roofing membrane including gravity flow drainage channels and channels perpendicular to and intersecting with the gravity flow channels. Such various drainage channels enhance lateral movement of water to thereby provide for even more rapid movement of water through the system, so that, for example, snow-melt water, or water backed up above a temporary snow damn may readily move through the photovoltaic roofing system.

The photovoltaic roofing system invention also includes a photovoltaic roofing system with quick-disconnect photovoltaic panels. The system includes an insulation layer positioned above a roofing membrane of a roof deck. Two or more spacers are positioned above the insulation layer so that the spacers define cooling voids between the spacers and above the insulation layer. A quick-disconnect photovoltaic panel is positioned above the spacers, and the quick-disconnect photovoltaic panel defines a plurality of quick-disconnect throughbores adjacent the cooling voids between the spacers. A quick-disconnect fastener-receiving sleeve is secured to the insulation layer and is also dimensioned to pass through one of the cooling voids and to also pass through a quick-disconnect throughbore of the photovoltaic panel.

A fastener having a flared end and a stem secured to the flared end is dimensioned so that the stem passes through the panel throughbore and into the quick-disconnect fastener-receiving sleeve to be secured within the sleeve by standard mechanical methods, such as a threaded sleeve and screw, etc. The flared end of the fastener is dimensioned to have a diameter greater than any diameter of the throughbore defined within the photovoltaic panel. Therefore, the flared end secures the photovoltaic panel to the insulation layer whenever the fastener is secured within the quick-disconnect fastener-receiving sleeve and the fastener permits disconnection of the photovoltaic panel from the insulation layer whenever the fastener is removed from the fastener-receiving sleeve.

Any quick-disconnect photovoltaic panels may therefore be readily removed from a photovoltaic roofing system without disrupting the insulation layer below the photovoltaic panels, and without risk of damage to adjacent photovoltaic panels, to repair or to replace the removed panel, etc. Additionally, all of the quick-disconnect panels may be removed to be replaced with upgraded photovoltaic panels without disrupting the insulation layer thereby minimizing any risk of damage to the roof membrane, and further minimizing cost of such repairs or upgrades.

The invention also includes a lightweight photovoltaic roofing system. The system includes a plurality of photovoltaic panels secured adjacent each other to define a photovoltaic region. Each photovoltaic panel is secured above a lightweight insulation panel so that each photovoltaic panel and insulation panel have a combined weight of between about 4 and about 5 pounds per square foot. The photovoltaic region defines an exterior perimeter extending around the entire photovoltaic region. A plurality of the lightweight insulation panels completely surrounds and interlocks with the exterior perimeter of the photovoltaic region and interlocks with each other to define a lightweight insulation panel ballast region. At least one insulation panel extends between the exterior perimeter of the photovoltaic region and an exterior perimeter of the lightweight insulation panel ballast region.

Each lightweight insulation panel weighs between about 4 and about 5 pounds per square foot. The lightweight system also includes a paver ballast perimeter that overlies lightweight insulation panel ballast region. The paver ballast perimeter weighs between about 12 and about 17 pounds per square foot, and the width of the paver ballast perimeter is less than half of a width of a photovoltaic panel, or preferably about 16 inches. (For purposes herein, the word “about” is to mean plus or minus 20 percent.)

Accordingly, it is a general purpose of the present invention to provide improved photovoltaic roofing components and a photovoltaic roofing system that overcomes deficiencies of the prior art.

It is a more specific purpose to provide improved photovoltaic roofing components and a photovoltaic roofing system that may be customized for particular conditions of a specific roof deck to thereby enhance performance, service and longevity of the photovoltaic roofing system.

These and other purposes and advantages of the present photovoltaic roof-top components, photovoltaic IRMA roofing system, and photovoltaic roofing system will become more readily apparent when the following description is read in conjunction with the accompanying drawing.

### BRIEF DESCRIPTION OF THE DRAWINGS

FIG. 1 is a fragmentary sectional view of a photovoltaic roofing system constructed in accordance with the present invention showing a limited number of drainage channels.

FIG. 2 is a fragmentary sectional view of a section of the FIG. 1 insulation layer of a photovoltaic roofing system showing a drainage channel.

FIG. 3 is a fragmentary sectional view of a second embodiment of a photovoltaic roofing system constructed in accordance with the present invention showing a substantial number of drainage channels.

FIG. 4 is a bottom view of an improved photovoltaic insulation layer showing a plurality of intersecting drainage channels.

FIG. 5 is a fragmentary sectional view of a dew point sensitive embodiment of a photovoltaic roofing system of the present invention on a metal roof deck and having a modest number of drainage channels.

FIG. 6 is a fragmentary sectional view of a dew point sensitive embodiment of a photovoltaic roofing system of the present invention on a metal roof deck and having a substantial number of drainage channels.

FIG. 7 is a fragmentary sectional view of an alternative embodiment of the present invention showing a photovoltaic IRMA (“inverted roofing membrane assembly”) system, and showing the system on a concrete roof deck and having a modest number of drainage channels defined within the insulation layer.

FIG. 8 is a fragmentary sectional view of the FIG. 7 alternative embodiment of the present invention showing the FIG. 7 photovoltaic IRMA system on a concrete roof deck and having a substantial number of drainage channels defined within the insulation layer.

FIG. 9 is a top schematic view of a photovoltaic roofing system on roof deck A in showing an upstream drainage area A.

FIG. 10 is a top schematic view of a photovoltaic roofing system on roof deck B showing an upstream drainage area B.

FIG. 11 is a top schematic view of a photovoltaic IRMA roofing system of the present invention showing a perimeter and internal areas not covered by photovoltaic panels.

FIG. 12 is a top plan, simplified schematic view of a quick-disconnect photovoltaic panel constructed in accordance with the present invention.

FIG. 13 is a fragmentary cross-sectional view taken along view lines 2-2 of FIG. 12, showing a quick-disconnect photovoltaic panel having a quick-disconnect fastener-receiving sleeve extending between an insulation layer and the panel.

FIG. 14 is an expanded sectional view of the FIG. 13 quick-disconnect fastener-receiving sleeve.

FIG. 15 is a fragmentary top plan view of a lightweight photovoltaic roofing system constructed in accordance with the present invention.

FIG. 16 is a fragmentary cross-sectional view of a segment of the FIG. 15 lightweight photovoltaic roofing system.

### DESCRIPTION OF THE PREFERRED EMBODIMENTS

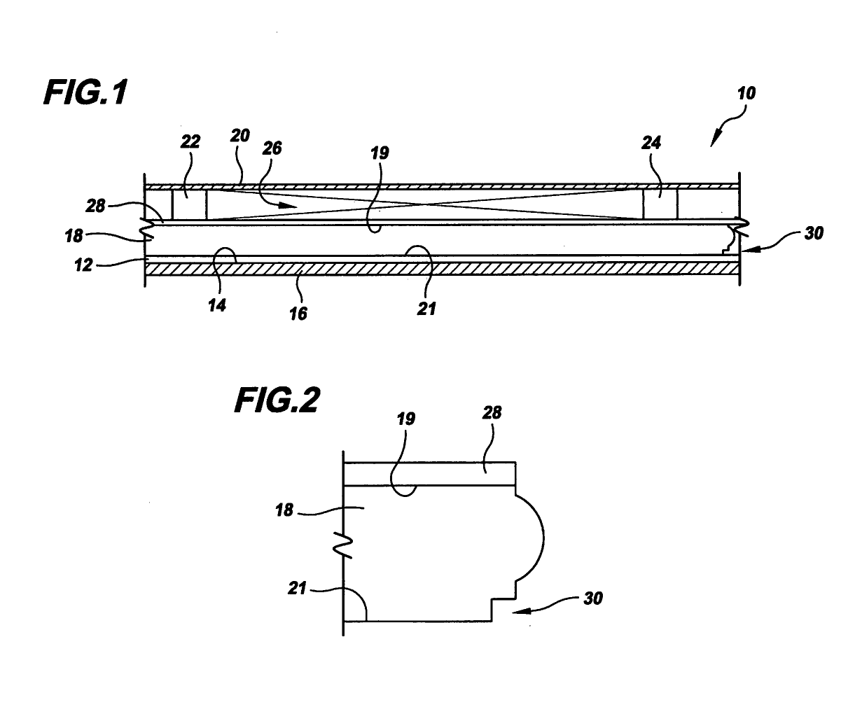

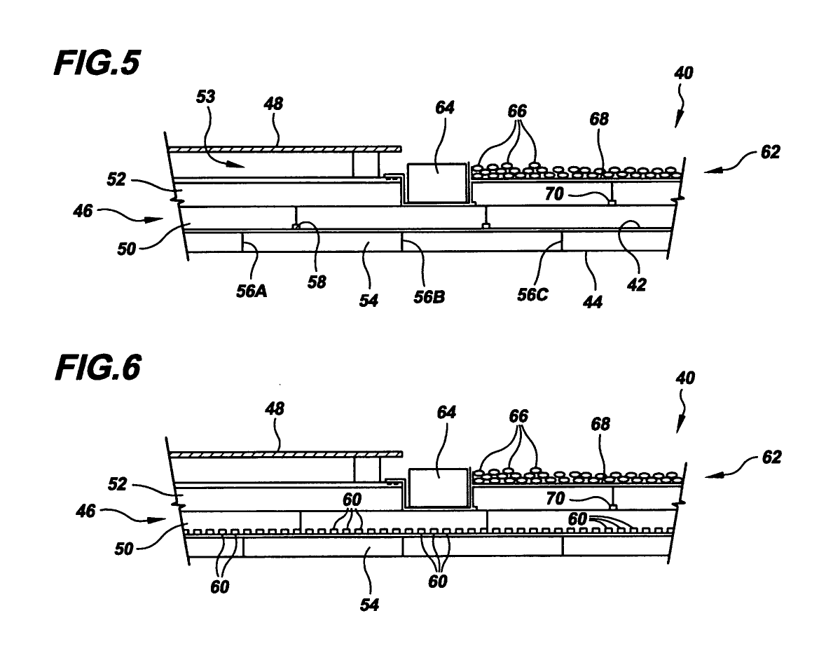

Referring to the drawings in detail, an improved photovoltaic roofing system is shown in FIG. 1, and is generally designated by the reference numeral 10. The system 10 includes a roofing membrane 12 overlying a top surface 14 of a roofing deck 16. An improved photovoltaic insulation layer 18 is above the roofing membrane 12. A photovoltaic panel 20 is above the insulation layer 18 and supported typically by way of insulation blocks or spacers 22, 24 that may provide an air space 26. (For purposes herein, the word “above” is to mean opposed to the direction of gravity. Additionally, hereinafter the phrase “secured to” is to mean either, “overlying”, “above” or “adjacent”, and does not mean that any securing apparatus or force is necessarily applied to adhere adjacent components to each other.) The improved insulation layer 18 may be secured to the photovoltaic panel 20 by being laminated to the panel 20, or to the panel spacers 22, 24, by lamination securing means known in the art. Alternatively, the panel 20 may simply be placed adjacent the insulation layer 18 if the panel 20 includes active thermal management, or in certain circumstances, the photovoltaic panel 20 may be located on top of ballast stone 66 above the insulation layer 18, as discussed in more detail below with respect to FIGS. 5, 6.

The photovoltaic insulation layer 18 may, and typically does, include a concrete topping 28 that provides ballast weight for the assembly or system 10 and other benefits well known in the art. This provides for “securing” described components to the roofing membrane 12. The insulation layer 18 defines a predetermined number of drainage channels 30, wherein only one drainage channel 30 is shown in FIG. 1. FIG. 2 shows an expanded view of the FIG. 1 drainage channel 30 defined in the insulation layer 18.

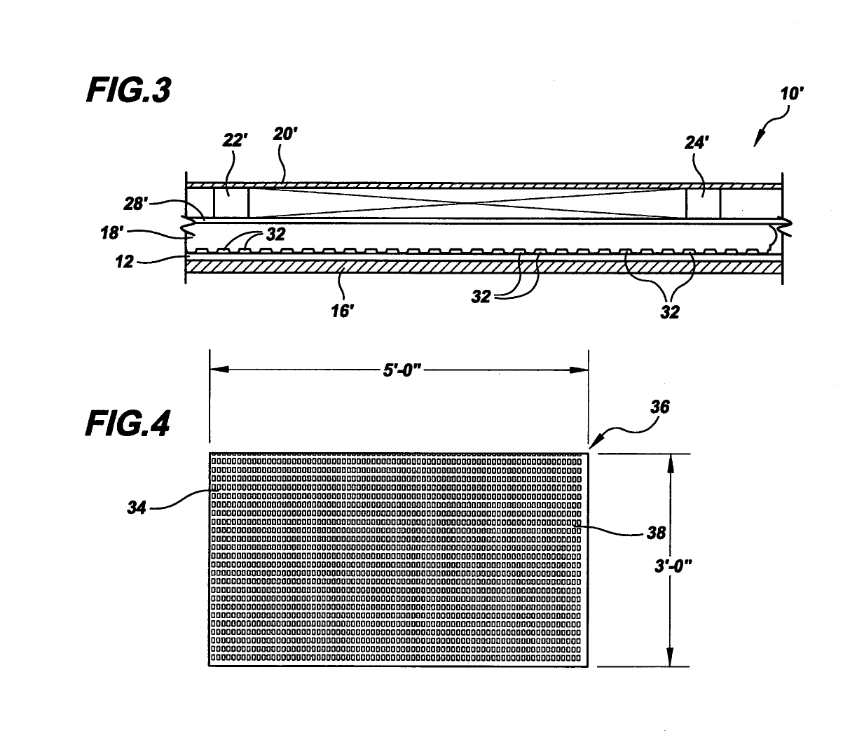

FIG. 3 shows a second embodiment of the photovoltaic roofing system 10′ (virtually identical elements of the FIG. 1 system 10 are shown with prime reference numerals (e.g., 10′) of the FIG. 1 reference numerals), wherein a much larger number of drainage channels 32 are shown defined in the insulation layer 18′ adjacent or above the roofing deck 16′. FIG. 4 shows a bottom plan view of a bottom surface 34 of an alternative insulation layer 36 wherein a plurality of drainage channels 38 intersect with each other to provide a checked appearance of the bottom surface 34. As described above, this provides for drainage in a direction parallel to a gravity flow axis, as well as in directions that are not parallel to the gravity flow axis to thereby provide for lateral movement to enhance overall flow rates for the drainage channels 38.

FIG. 5 shows a second alternative, or dew-point sensitive photovoltaic roofing system 40 that includes a roofing membrane 42 secured to a sub-membrane insulation layer 54 that is secured above the metal deck 44, and a photovoltaic panel 48 secured adjacent to or above an insulation layer 46 secured above the-roofing membrane 42. (As shown in FIG. 5, the insulation layer 46 may consist of one solid insulation substance, or a plurality of stacked insulation sheets 50, 52 below an air space 53.) The sub-membrane insulation layer 54 is secured between the roof deck 44 (such as the metal deck 44 having sub-membrane insulation panels 56A, 56B, 56C) and the roofing membrane 42. As described above, the sub-membrane insulation layer 54 may be of a predetermined thickness, and, based upon measurements to determine the predetermined thickness of the sub-membrane insulation layer 54, the insulation layer 46 above the roofing membrane 42 has a predetermined thickness wherein its predetermined thickness is a function of the thickness of the sub-membrane insulation layer 54 so that the “R” value of the insulation layer 46 above the roofing membrane 42 is greater than the “R” value of the insulation layer 54 below the membrane 42. This dew-point sensitive embodiment of the improved photovoltaic roofing system thereby eliminates any condensation of moisture between the sub-membrane insulation layer 54 and the roofing membrane 42 and/or the roofing deck 44.

FIG. 6 shows the FIG. 5 or dew-point sensitive photovoltaic roofing system 40, but with the insulation layer 46 defining a substantial number of drainage channels 60 to facilitate drainage of a much greater flow of water.

The photovoltaic roofing system 40 of FIGS. 5 and 6 also includes components that would be adjacent an edge of the system 40, between the photovoltaic panel 48 and an exterior edge 62 of the system 40. Included are a concrete block 64, and a plurality of ballast stones 66 and a filter fabric 68 to permit movement of only filtered rain water through the ballast stones 66 and down into an exterior drainage channel 70 for movement of such rain water through and out of the roofing system 40.

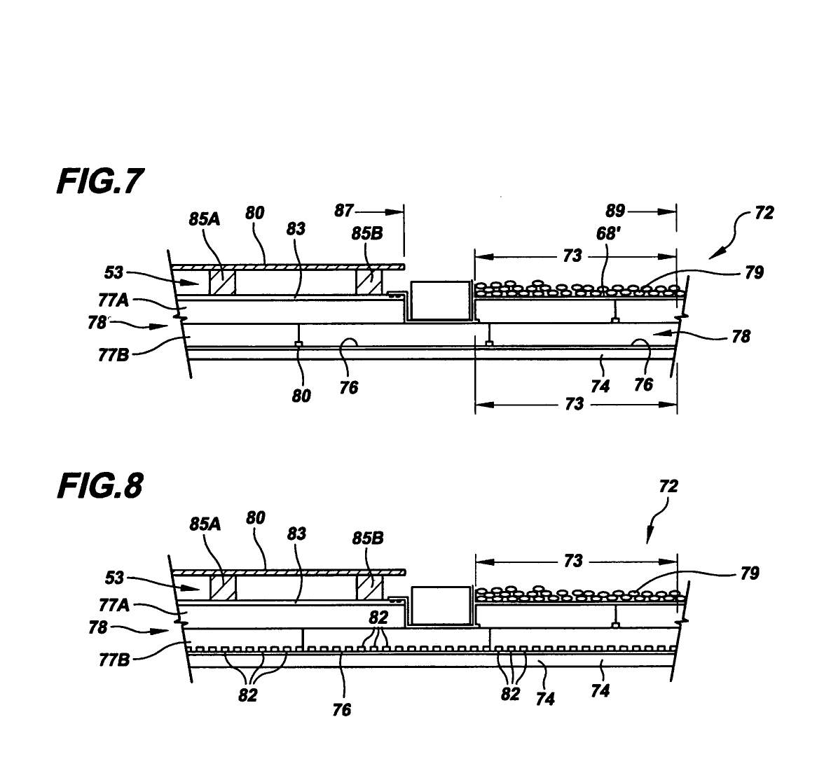

FIGS. 7 and 8 show a third alternative or photovoltaic IRMA roofing system 72 that has very similar components as the roofing system 40 shown in FIGS. 5 and 6. A section of a traditional IRMA (“inverted roofing membrane assembly”) roof system 73 is shown in FIG. 7 as part of the photovoltaic IRMA system 72. It includes the roofing membrane 76 above and adjacent to a standard roof deck 74; an insulation layer 78 that may be one or more layers secured above the roofing membrane 76; and ballast material 79 that may consist of stone, concrete layers, or anything known in roofing technology utilized for adding ballast to insulation layers 78, and secured above the insulation layer 78. The traditional IRMA system 73 may also include a filter fabric 68′ for restricting passage of large particles passing through the insulation layer with rain water to restrict clogging insulation drainage channels. The photovoltaic IRMA roofing system 72 shown in FIGS. 7 and 8 to the left of the traditional IRMA roofing system 73 includes the roofing membrane 76 above and immediately adjacent to the roof deck 74; the insulation layer 78 secured above the roofing membrane 76; ballast material such as a concrete topping 83 secured adjacent the insulation layer 78; and a photovoltaic panel 80 secured above the concrete topping 83 of the insulation layer 78. The photovoltaic panel 80 may be secured above the concrete topping 83 of the insulation layer 78 on a plurality of spacers 85A, 85B to define an air space 53 between the panel 80 and insulation layer 78 that facilitates removal of heat from the panel 80. The insulation layer 78 may also consist of a plurality of insulation layers 77A, 77B to provide enhanced insulation, or to utilize thinner layers 77A, 77B stacked together.

As is apparent in FIGS. 7 and 8, the photovoltaic IRMA roofing system 72 provides for replacement of the traditional ballast material 79 with the combination of the weight of the photovoltaic panel 80 and concrete topping 83 ballast material on the insulation layer 78. As is known, traditional IRMA roofing systems require a predetermined minimum weight per unit area requirement to prevent disruption of the system by prevailing winds or other related weather phenomenon. By using the combination of the weight of the photovoltaic panel 80 and the concrete topping 83 or any similar ballast material adjacent the insulation layer 78 between the photovoltaic panel 80 and the roofing membrane 76, the photovoltaic IRMA roofing system 73 efficiently satisfies the predetermined minimum weight per unit area requirement of any specific roof while minimizing any risk of exceeding a maximum weight load of the underlying roof deck 74. As recited above, this is particularly valuable when improving an existing IRMA roof system by adding photovoltaic panels 80 to enhance the energy efficiency of a building supporting the roof deck 74. The same benefit may be realized when totally removing an existing “membrane-over-insulation” roofing system and replacing it with the above referenced photovoltaic IRMA roofing system 72 provided the existing underlying roof deck 74 is analyzed for its ability to carry the additional load. The photovoltaic IRMA roofing system 72 also minimizes a weight load, cost of materials and assembly for any new roof system that is to include photovoltaic panels 80.

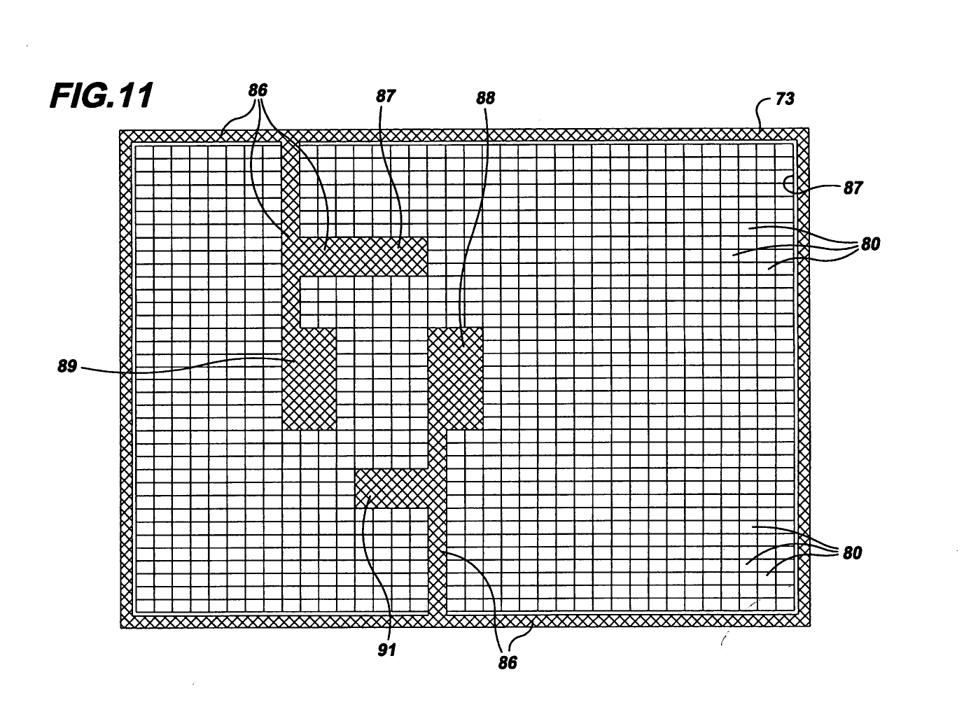

As shown in FIGS. 7 and 8, it is common that a photovoltaic IRMA roofing system 72 includes photovoltaic panels 80 that extend only to a photovoltaic panel perimeter 87. Between the photovoltaic panel perimeter 87 and a roofing system exterior perimeter 89 there may be a section of a traditional IRMA roofing system 73, such as shown in FIGS. 7 and 8. There may be similar excluded areas that are internal to the photovoltaic panel perimeter 87. The photovoltaic panel perimeter 87 is defined by requirements of rooftop mechanical system such as stairs, related walk areas and other penetrations of the roofing membrane 76. For example and as shown in FIG. 11 such internal areas having no overlying photovoltaic panels 80 include access aisles 86, stair bulkheads 87, elevator mechanical rooms 88, HVAC systems 89, and vent stack and exhaust fan areas 91. The traditional IRMA roofing system section 73 together with the photovoltaic IRMA system 72 ensures that the entire roofing systems functions as an IRMA roofing system 72, so that the system 72 satisfies the predetermined minimum weight per unit area requirement specific to the roof deck 74.

It is also pointed out that, the third alternative photovoltaic IRMA roofing system 72 may be secured to a metal or a non-metal roof deck 74. The third alternative photovoltaic IRMA roofing system 72 shows, similarly to the second embodiment in FIGS. 5 and 6, a distinction between only one drainage channel 80 in FIG. 7 and a plurality of channels 82 in FIG. 8. Additionally, this third embodiment shown in FIGS. and 8 of the system 72 may not include the sub-membrane insulation layer 54 of the second embodiment of FIGS. 5 and 6.

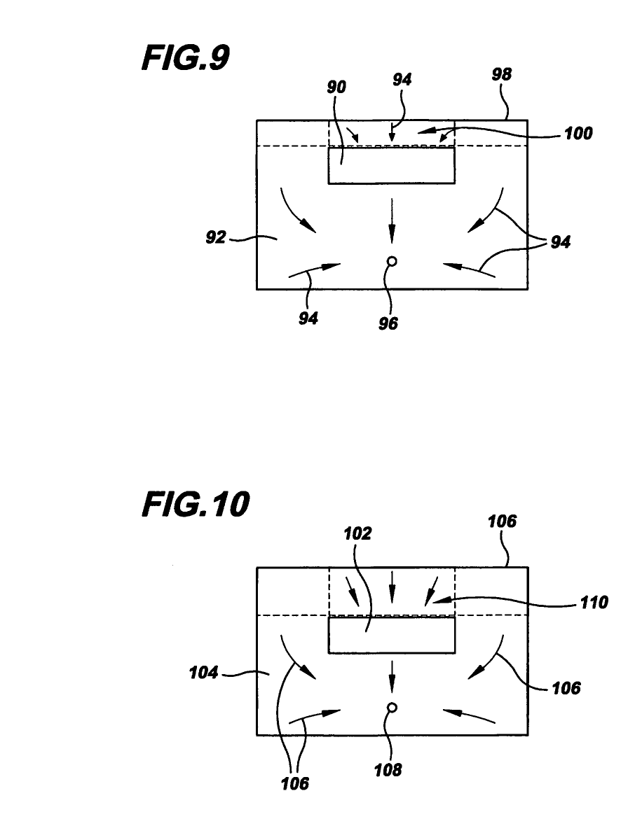

An additional advantage of the present photovoltaic assemblies or system 10 and its individual components is shown in FIGS. 9 and 10, wherein a first photovoltaic panel A 90 is shown in FIG. 9 secured to a roofing deck 92. Direction of flow by gravity arrows 94 identify a gravity flow direction to a drain 96 for rain water or accumulated snow-melt water (not shown). The photovoltaic panel A 90 is positioned in close proximity to an edge 98 of the roofing deck 92 so that an upstream drainage area A 100 is defined between the panel A 90 and the edge 98 of the roofing deck. FIG. 10 shows a photovoltaic panel B 102 secured to a roof deck B 104 a further distance from an edge 104, wherein flow arrows 106 show gravity flow directions to a drain 108. As is apparent, an upstream drainage area B 110 is significantly larger than the upstream drainage area A of FIG. 9. Therefore, the photovoltaic roofing system 102 of FIG. 10 requires a significantly larger water drainage flow capacity than the photovoltaic roofing system 90 of FIG. 9 to deal with the varying sizes of the upstream drainage areas A 100 and B 110.

The present invention also includes the described insulation panel 18 as an improved photovoltaic insulation layer 18 for a photovoltaic roofing system 10. 40, 72. The improved photovoltaic insulation layer 18 has a top surface 19 and an opposed bottom surface 21 (see FIGS. 1 and 2) wherein the bottom surface 21 defines a predetermined number of drainage channels 30. The predetermined number of drainage channels 30 is a function of variable drainage requirements, as described above. Additionally, the improved photovoltaic insulation layer 18 has a predetermined insulation layer thickness between its opposed top surface 19 and bottom surfaces 21, wherein the predetermined insulation layer thickness is a function of variable insulation requirements of the roofing system 10, 40, 72, as described above.

As is well known in the art, the schematics of FIGS. 9 and 10 show simplified, demonstrative systems 90, 102 only. In actual installation of photovoltaic roof-top assemblies or systems 10, 40, 72, many photovoltaic panels 20 are combined with multiple insulation sheets 18 to cover large, often irregular areas of essentially flat roofs. Therefore, by the present photovoltaic roofing assembly or system 10, 40, 72, sensitive adjustments of both the drainage capacity and insulation capacity may be made to customize the roofing system 10, 40, 72 to meet varying, specific drainage and insulation requirements of large photovoltaic roof system installations, such as are now common on the roofs of increasingly large “big box” stores of contemporary malls, schools, large manufacturing and similar facilities, etc.

While the vast majority of photovoltaic roof-top assemblies or systems 10, 40, 72 applies to use of panels 20 that directly convert solar energy into electrical energy, it is to be understood that for purposes herein, the phrases “photovoltaic roofing system”, “photovoltaic roof-top assemblies” or “roofing systems” are to include systems that convert solar energy directly to electrical energy, as well as any roofing system that captures solar energy for any purposes, including for capture of heat energy, etc. Additionally, the phrase “insulation layer defines drainage channels” means that the drainage channels permit flow of liquids from opposed edges of the insulation layer so that the liquids flowing through the photovoltaic roofing system 10 flow from an upstream end of the system through to and out of a downstream end of the system, or out of sides of the system 10. The phrase “insulation layer defines drainage channels” may also mean that drainage channels simply lie between insulation sheets of the insulation layer 18 and the roofing membrane 12, such as by application of fluid conduits (e.g., pipes, hoses, lines, carved tunnels, carved channels, etc.) to or in the insulation sheets 50, 52.

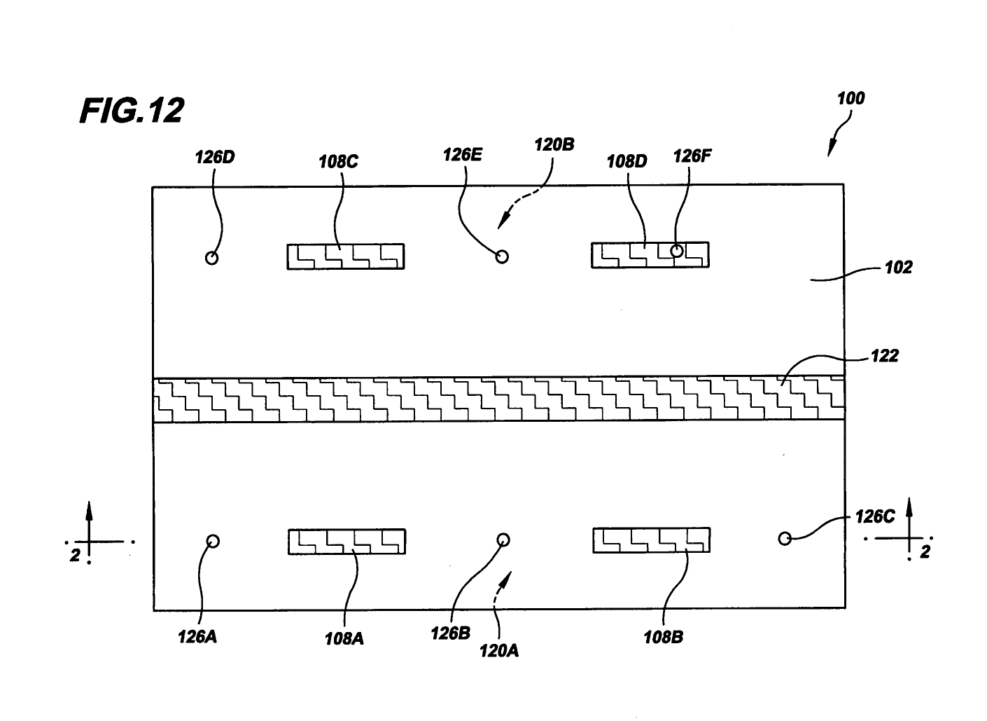

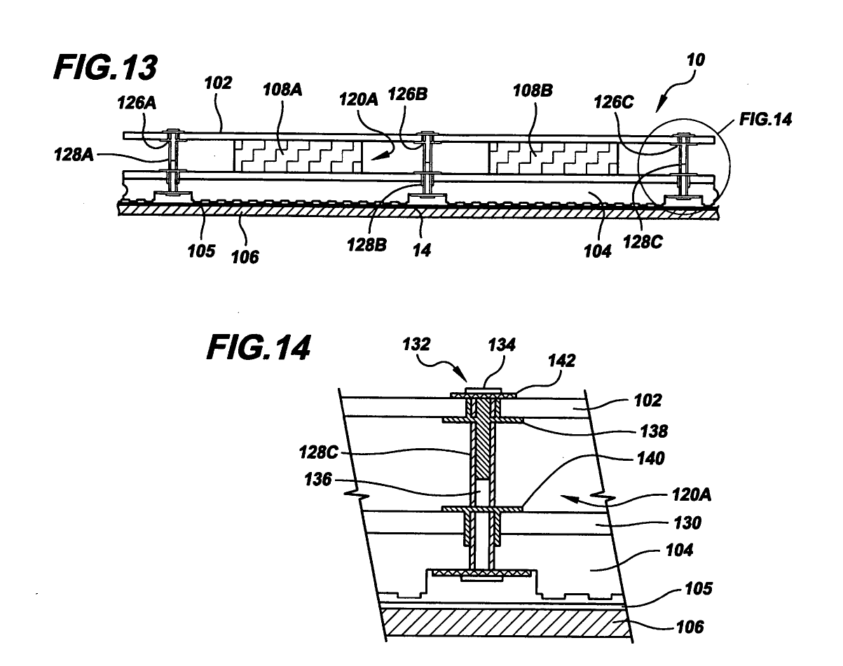

The photovoltaic roofing system of the present invention also includes a quick-disconnect photovoltaic roofing system 100 with a quick-disconnect photovoltaic panel 102 that is shown in FIGS. 12 and 13 and is generally designated by the reference numeral 100. The system 100 includes an insulation layer 104 positioned above a roofing membrane 105 above a roof deck 106. Two or more spacers 108A, 108B, 108C, 108D and 122 are positioned above the insulation layer 104 so that the spacers define cooling voids 120A, 120B between the spacers 108A-108D, and above the insulation layer 104. An insulation spacer may take the form of an insulation spacer-support block 122 in variable positions and in variable heights, as shown in FIG. 12, which may also be used to provide further support, and that may also divide the cooling voids 120A, 120B.

A quick disconnect photovoltaic panel 102 is positioned above the spacers 108A-108D, and the quick-disconnect photovoltaic panel 102 defines a plurality of quick-disconnect throughbores 126A, 126B, 126C, 126D, 126E, 126F adjacent the cooling voids 120A, 120B between the spacers 108A-108D. A plurality of quick-disconnect fastener-receiving sleeves 128A, 128B, 128C (shown best in FIGS. 13 and 14) are secured to the insulation layer 104 and are also dimensioned and positioned to pass through one of the cooling voids 120A, 120B or through the spacers 108A-108D and to also pass through corresponding quick-disconnect throughbores 126A, 126B, 126C of the quick-disconnect photovoltaic panel 102. It is pointed out that in the FIG. 14 expanded view of the quick-disconnect fastener-receiving sleeve 128C, a layer of concrete 130 or “concrete topping” is shown secured to the insulation layer 104.

For purposes of clarity in explanation, this description will describe one fastener 132, while it will be understood by those skilled in the art that virtually identical fasteners are deployed within each of the quick-disconnect throughbores 126A-126F and fastener-receiving sleeves 128A-128D. The fastener 132 has a flared end 134 and a stem 136 that is secured to the flared end 134, and the fastener 132 is dimensioned so that the stem 136 passes through the panel throughbore 126C and into the quick-disconnect fastener-receiving sleeve 128C to be secured within the sleeve by standard mechanical methods, such as a threaded sleeve and screw, etc. The flared end 134 of the fastener 132 is dimensioned to have a diameter greater than any diameter of the throughbore 126C defined within the photovoltaic panel 102. Therefore, the flared end 134 secures the photovoltaic panel 102 to the insulation layer 104 whenever the fastener 132 is secured within the quick-disconnect fastener-receiving sleeve 128C and the fastener 132 permits disconnection of the photovoltaic panel 102 from the insulation layer 104 whenever the fastener 132 is removed from the fastener-receiving sleeve 128C. The insulation layer 104 may be secured to an adjacent roof membrane 105 by any means known in the art.

While the fastener 132 and corresponding receiving sleeve 128C have been described as a conventional threaded sleeve and threaded bolt, it is to be understood that any quick-disconnect fastening means may be utilized that is known in the art and that is capable of securing the photovoltaic panel 102 to the insulation layer 104 above the cooling voids 120A, 120B, such as bolts and nuts, instead of sleeves, washer-defined sleeves, securing rods with pivot latches at terminal ends, etc. As shown in FIG. 14, the quick-disconnect fastening means 132 may also include a panel grommet 138 surrounding the photovoltaic panel throughbore 128C, and an insulation layer grommet 140 as part of a mechanism to secure the fastener-receiving sleeve 128C to the insulation layer 104. In addition, a panel washer 142 may be utilized between the flared end 134 of the fastener 132 and the photovoltaic panel 124 to diffuse compressive forces against the panel 102. Additionally, the panel washer 142 may be made of a hard translucent material to facilitate transmission of light into the panel 102.

As described above, the quick-disconnect photovoltaic panel 102 may therefore be readily removed from the quick-disconnect photovoltaic roofing system 100 without disrupting the insulation layer 104 below the photovoltaic panel 102, and without risk of damage to any adjacent photovoltaic panels (not shown), to repair or to replace the removed panel 102, etc.

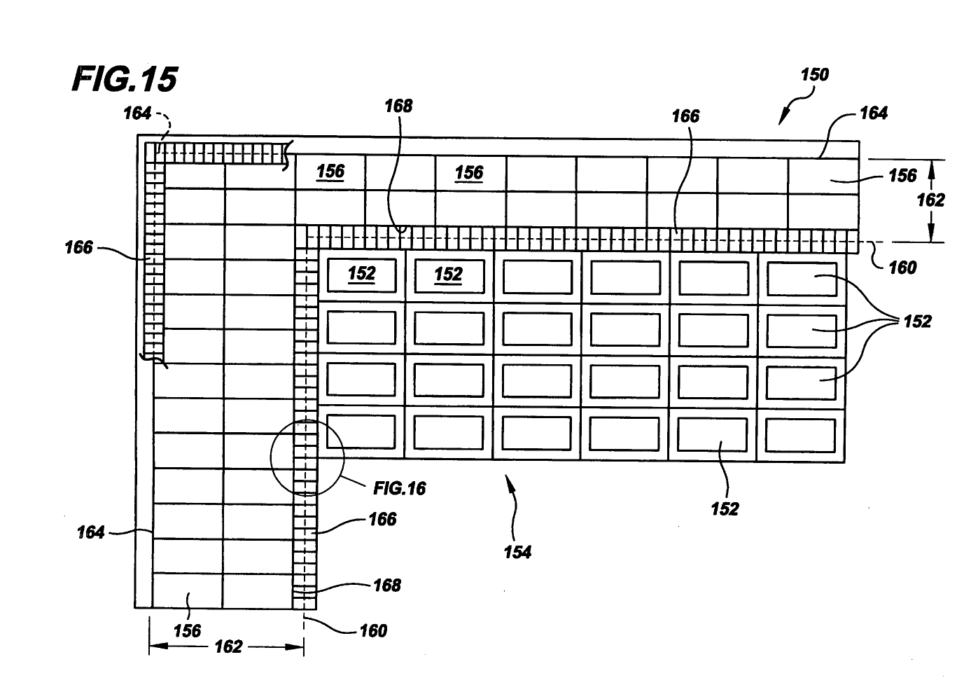

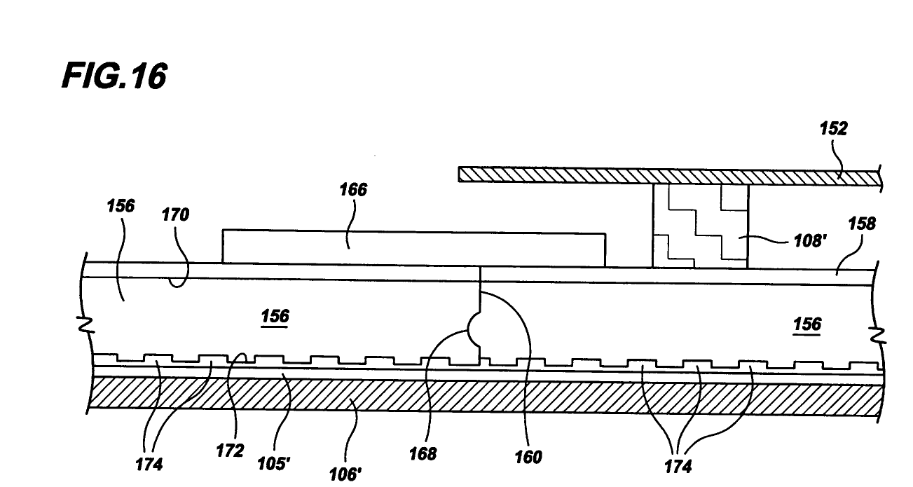

As shown best in FIGS. 15 and 16, the invention also includes a lightweight photovoltaic roofing system 150. The system 150 includes a plurality of photovoltaic panels 152 secured adjacent each other to define a photovoltaic region 154. Each photovoltaic panel 152 is secured above a lightweight insulation panel 156 (shown best in FIG. 16) having a concrete topping 158, and having a top surface 170 below the concrete layer 158 and an opposed bottom surface 172, wherein the bottom surface 172 may also define a predetermined number of drainage channels 174. The light weight insulation panels 156 are secured adjacent a roofing membrane 105′ above a roofing deck 106′, and the lightweight insulation panels 156 typically support insulation spacers 108′ as described above and known in the art. Each photovoltaic panel 152 and adjacent insulation panel 156 with its concrete topping 158 have a combined weight of between about four and about five pounds per square foot.

The photovoltaic region 154 defines an exterior perimeter 160 extending around the entire photovoltaic region 154. A plurality of the lightweight insulation panels 156 completely surrounds and interlocks with the exterior perimeter 160 of the photovoltaic region 154 and interlocks with each other 156 to define a lightweight insulation panel ballast region 162. At least one insulation panel 156 extends between the exterior perimeter 160 of the photovoltaic region 154 and an exterior perimeter 164 of the lightweight insulation panel ballast region 164. Additional insulation panels 156 may extend between the exterior perimeter 160 of the photovoltaic region and the exterior perimeter 164 of the lightweight insulation panel ballast region 164 if the area of the roof permits, and if additional ballast is needed.

Each lightweight insulation panel 156 weighs between about four and about five pounds per square foot. The lightweight photovoltaic system 150 also includes a paver ballast perimeter 166 that overlies the lightweight insulation panel ballast region 162. In varying embodiments, the paver ballast perimeter 166 may overlie the exterior perimeter 160 of the photovoltaic region 154 and simultaneously overlie an interior perimeter 168 of the lightweight insulation panel ballast region 164 (as shown in FIGS. 15 and 16). Alternatively, the paver ballast perimeter 166 may overlie and exterior perimeter 164 of the lightweight insulation panel ballast region 162 (as shown in FIG. 15). Or, if circumstances permit, the paver ballast perimeter 166 may simply overlie the lightweight panel ballast region 164 wherever convenient. The paver ballast perimeter 166 weighs between about twelve and about seventeen pounds per square foot, and the width of the paver ballast perimeter 166 may be less than half of a width of a photovoltaic panel 152, or preferably about sixteen inches. (For purposes herein, the word “about” is to mean plus or minus 20 percent.)

Use of the word “interlocks” in the above description: “A plurality of the lightweight insulation panels 156 completely surrounds and interlocks with the exterior perimeter 160 of the photovoltaic region 154 and interlocks with each other 156 to define . . . ” will now be described. By stating that a plurality of the insulation panels 156 . . . “interlocks”, it is meant to include the type of “tongue and groove” mechanical interlocking shown in FIG. 16 at the interface of reference numerals 160 and 168. However, the word “interlocks” is also meant to include any other known mechanical, adhesive, gravity-based (e.g., overlapping edges), bonding, fusing, etc., known in the art that can achieve the described function of the plurality of lightweight insulation panels 156 adding to the ballast necessary to hold down the lightweight photovoltaic roofing system 150 from movement or other damage from wind forces acting upon the system 150. The lightweight photovoltaic roofing system 150 and/or the quick-disconnect photovoltaic panels 102 may also include the improved photovoltaic insulation layer 18 described above.

Use of the lightweight photovoltaic roofing system 150 provides a more efficient system 150 that may be used on roofs that would prohibit use of known systems because of weight restrictions of the roof 106′. Use of the quick-disconnect photovoltaic panels 102 provides for rapid removal of damaged panels, or of outdated panels with minimal risk of damage to the roof membrane 105, 105′, roof deck 106, 106′ and/or adjacent panels, and minimizes cost of such replacement by retaining an existing insulation layer 104 and any ballast components 156, 166. The quick-disconnect photovoltaic panels 102 may be used in known photovoltaic systems, or the photovoltaic systems 10, 40, 72, 150 of the present invention described above.

While the present invention has been disclosed with respect to the described and illustrated embodiments, it is to be understood that the invention is not to be limited to those embodiments. Accordingly, reference should be made primarily to the following claims rather than the foregoing description to determine the scope of the invention.

What is claimed is:

1. A photovoltaic insulation layer (18) for a photovoltaic roofing system (10), the photovoltaic insulation layer (18) comprising:
a. a top surface (19) and an opposed bottom surface (21), wherein the bottom surface defines a predetermined number of drainage channels (32);
b. the predetermined number of drainage channels (32) being a function of variable drainage requirements of the photovoltaic roofing system (10).

2. The photovoltaic insulation layer (18) of claim 1, wherein the photovoltaic insulation layer (18) defines a predetermined insulation layer thickness between the top surface (19) and the opposed bottom surface (21), the predetermined thickness being a function of variable insulation requirements of the photovoltaic roofing system (10).

3. The photovoltaic insulation layer (18) of claim 1, wherein the insulation layer (18) is secured above a roofing membrane (12) overlying a top surface (14) of a roof deck (16), a photovoltaic panel (20) is secured above the insulation layer (18), a sub-membrane insulation layer (54) is secured between the top surface (14) of the roof deck (16) and the roofing membrane (12), and wherein the sub-membrane insulation layer (54) defines a predetermined sub-membrane insulation layer (54) thickness, and the insulation layer (18, 46) above the roofing membrane defines a predetermined thickness that is a function of the sub-membrane insulation layer (54) thickness so that the insulation layer (18, 46) above the roofing membrane has a greater resistance to movement of heat (“R”) value than the sub-membrane insulation layer (54).

4. A photovoltaic IRMA roofing system (72), comprising:
a. a roofing membrane (76) overlying a top surface of a roof deck (74);
b. an insulation layer (78) secured above the roofing membrane (76);
c. ballast material (79) secured to and above the insulation layer (78);
d. a photovoltaic panel (80) above and secured to the insulation layer; and,
e. wherein the combined weight of the ballast material (79) and the photovoltaic panel (80) are equal to or greater than a predetermined minimum weight per unit area requirement for the roofing system (72).

5. The photovoltaic IRMA roofing system (72) of claim 4, wherein the ballast material (79) comprises a concrete topping (83) secured to the insulation layer (78).

6. The photovoltaic IRMA roofing system of claim 4, wherein the insulation layer (18, 78) includes a top surface (19) and an opposed bottom surface (21), the bottom surface (21) defining a predetermined number of drainage channels (30), the predetermined number of drainage channels (30) being a function of variable drainage requirements of the photovoltaic IRMA roofing system (72).

7. The photovoltaic IRMA roofing system (72) of claim 6, wherein the insulation layer (18, 78) includes a top surface (19) and an opposed bottom surface (21), the insulation layer defining a predetermined insulation layer thickness between the top surface (19) and the opposed bottom surface (21), and the predetermined thickness being a function of variable insulation requirements of the photovoltaic IRMA roofing system (72).

8. The photovoltaic IRMA roofing system (72) of claim 4, further comprising a sub-membrane insulation layer (54) secured between the top surface (14) of the roof deck (16, 74) and the roofing membrane (76), wherein the sub-membrane insulation layer (54) defines a predetermined sub-membrane insulation layer (54) thickness, and the insulation layer (78) above the roofing membrane defines a predetermined thickness that is a function of the sub-membrane insulation layer (54) thickness so that the insulation layer (78) above the roofing membrane has a greater resistance to movement of heat (“R”) value than the sub-membrane insulation layer (54).

9. A photovoltaic roofing system (100) with quick-disconnect photovoltaic panels (102), comprising:
a. an insulation layer (104) positioned above a roofing membrane (105) of a roof deck;
b. a plurality of spacers positioned above the insulation layer (104) so that the spacers (108A, 108B, 108C, 108D) define cooling voids (120A, 120B) between the spacers (108A, 108B, 108C, 108D) and above the insulation layer (104);
c. a quick-disconnect photovoltaic panel (102) positioned above the spacers (108A, 108B, 108C, 108D), the quick-disconnect photovoltaic panel (102) defining a plurality of quick-disconnect throughbores (126A, 126B, 126C, 126D, 126E, 126F) adjacent the cooling voids (120A, 120B);
d. a quick-disconnect fastener-receiving sleeve (128A) secured to the insulation layer (104) and dimensioned to pass through a cooling void (120A) and through a quick-disconnect throughbore (126A-126F) of the photovoltaic panel (102); and,
e. quick-disconnect fastening means for securing the photovoltaic panel (102) to the insulation layer (104) above the cooling voids (120A, 120B) and for permitting disconnection of the photovoltaic panel (102) from the insulation layer (104) whenever the quick-disconnect fastening means (132) is removed from the fastener-receiving sleeve (128A).

10. The photovoltaic roofing system (100) with quick-disconnect photovoltaic panels (102)of claim 9, wherein the quick-disconnect fastening means comprises a fastener (132) having a flared end (134) and a stem (136) secured to the flared end (134) and dimensioned so that the stem (136) passes through the panel throughbore (126A-126F) and into the quick-disconnect fastener-receiving sleeve (128F) to be secured within the sleeve (128F) and wherein the flared (134) end is dimensioned to have a diameter greater than any diameter of the throughbore (126A-126F) defined within the photovoltaic panel (102) so that the flared end (134) thereby secures the photovoltaic panel (102) to the insulation layer (104) whenever the fastener (132) is secured within the quick-disconnect fastener-receiving sleeve (128A) and permits disconnection of the photovoltaic panel (102) from the insulation layer (104) whenever the fastener (132) is removed from the fastener-receiving sleeve (128).

11. The photovoltaic roofing system (100) with quick-disconnect photovoltaic panels (102) of claim 9, wherein the insulation layer (18, 104) comprises:
a. a top surface (19) and an opposed bottom surface (21), wherein the bottom surface defines a predetermined number of drainage channels (30);
b. the predetermined number of drainage channels (30) being a function of variable drainage requirements of the photovoltaic roofing system (100).

12. The photovoltaic roofing system (100) with quick-disconnect photovoltaic panels of claim 11, wherein the insulation layer (18, 104) further defines a predetermined insulation layer thickness between a top surface (19) and the opposed bottom surface (21), the predetermined thickness being a function of variable insulation requirements of the photovoltaic roofing system (100).

13. A lightweight photovoltaic roofing system (150), comprising:
a. a plurality of photovoltaic panels (152) secured adjacent each other defining a photovoltaic region (154), wherein each photovoltaic panel (152) is secured above a lightweight insulation panel (156) so that each photovoltaic panel (152) and insulation panel (156) have a combined weight of between about four and about five pounds per square foot;
b. the photovoltaic region (154) defining an exterior perimeter (160) extending around the entire photovoltaic region (154);
c. a plurality of the lightweight insulation panels (156) completely surrounding and interlocking with the exterior perimeter (160) of the photovoltaic region (154) and interlocking with each other to define a lightweight insulation panel ballast region (164) so that at least one insulation panel (156) extends between the exterior perimeter (160) of the photovoltaic region (154) and an exterior perimeter (164) of the lightweight insulation panel ballast region (164), wherein each lightweight insulation panel (156) weighs between about four and about five pounds per square foot; and,
d. a paver ballast perimeter (166) overlying the photovoltaic region (154), wherein the paver ballast perimeter (166) weighs between about twelve and about seventeen pounds per square foot, and wherein the width of the paver ballast perimeter (166) is less than half of a width of a photovoltaic panel (152).

14. The lightweight photovoltaic roofing system (150) of claim 13, wherein the insulation layer (18, 156) comprises:
a. a top surface (19) and an opposed bottom surface (21), wherein the bottom surface (21) defines a predetermined number of drainage channels (30);
b. the predetermined number of drainage channels (30) being a function of variable drainage requirements of the lightweight photovoltaic roofing system (150).

15. The lightweight photovoltaic roofing system of claim 14, wherein the insulation layer (18, 156) further defines a predetermined insulation layer (21) thickness between a top surface (19) and the opposed bottom surface, the predetermined thickness being a function of variable insulation requirements of the lightweight photovoltaic roofing system (150).
